(19) United States
(12) Patent Application Publication
(10) Pub. No.: US 2009/0011308 A1
(43) Pub. Date: Jan. 8, 2009

(54) Preparation of Gas Diffusion Layer for Fuel Cell

(76) Inventors: Eun-Sook Lee, Gyeonggi-do (KR); Kyoung-Hun Yang, Gyeonggi-do (KR); Hee-Rok Jung, Gyeonggi-do (KR); Tae-Hee Kim, Seoul (KR); Sun-Kyung Han, Seoul (KR); Jeong-Kyou Lee, Gyeonggi-do (KR); Yun-Hee Seo, Gyeonggi-do (KR); Jong-Ho Park, Seoul (KR)

Correspondence Address: John W. Renner;Renner, Otto, Boisselle & Sklar, 1621 Euclid Avenue, 19th Floor, Cleveland, OH, 44115, US

(21) Appl. No.: 12/223,566

(22) PCT Filed: Feb. 2, 2007
(86) PCT No.: PCT/KR2007/000573

§ 371 Date: Jul. 31, 2008

(30) Foreign Application Priority Data
Feb. 2, 2006 (KR) 10-2006-0010078

(51) Int. Cl. H01M 4/96; H01M 4/04

(52) U.S. Cl. 429/27; 427/115

(57) ABSTRACT

A common method of preparing a gas diffusion layer for a fuel cell has problems in that a microporous layer is impregnated into a substrate, thereby lowering the porosity of the substrate, and cracks are created on a surface of a gas diffusion layer prepared using the method. Provided is a method of reproducibly preparing a gas diffusion layer with a uniform thickness and no cracks based on the principle of a primer coating method, wherein a first microporous layer is hardly impregnated into a substrate and uniformly covers a surface of the substrate, and at least one microporous layer is further coated on the first microporous layer. Provided is also a fuel cell showing improved performance by enhancing utilization of a catalyst layer and guaranteeing a uniform diffusion of fuel and an efficient discharge of a product.

### TECHNICAL FIELD

The present invention relates to a method of preparing a gas diffusion layer for a fuel cell, and more particularly, to a method of preparing a gas diffusion layer for a fuel cell, which has a uniform thickness, no cracks, and good reproducibility.

### BACKGROUND ART

Polymer electrolyte membrane fuel cells (PEMFCs) can be classified into fuel cells using hydrogen or a hydrocarbon gas and direct methanol fuel cells (DMFCs) using an aqueous methanol solution according to the type of fuel which is supplied to a fuel electrode. As compared with other fuel cells, PEMFCs have features such as a low operating temperature, high efficiency, high current density and energy density, short starting time, and a rapid response speed in response to a load change. When comparing PEMFCs with secondary batteries that have been developed as power sources of electric vehicles, PEMFCs have an energy density of about 200 to several thousands Wh/kg, while secondary batteries have an energy density of about 200 Wh/kg or less. That is, PEMFCs have much higher energy density than secondary batteries. In terms of a charging time, lithium secondary batteries require a charging time of about three hours, whereas PEMFCs require a fuel injection time of merely several seconds. Thus, PEMFCs can be used as transportation power sources which are substitutes for batteries of electric vehicles, mobile and emergency power supplies, power supplies for military applications, etc.

PEMFCs include a membrane electrode assembly (MEA) including a fuel electrode, an air electrode, and a polymer electrolyte membrane interposed between the fuel electrode and the air electrode, and a bipolar or monopolar plate serving as an electric conductor and including a channel through which fuel or a gaseous oxidizer flows to contact with the electrodes. A hydrogen gas or an aqueous methanol solution is generally supplied as fuel to the fuel electrode. In the fuel electrode, hydrogens are decomposed into hydrogen ions and electrons. The hydrogen ions migrate toward the air electrode through the electrolyte membrane, and the electrons migrate toward the air electrode through conductive lines and loads constituting an external circuit. An oxidizer, generally air is supplied to the air electrode. In the air electrode, the hydrogen ions and the electrons react with oxygen in the air to generate water.

In order to enhance the performance of PEMFCs, it is important to construct PEMFCs such that fuel fully flows into a fuel electrode to uniformly diffuse into a catalyst layer, and a generated byproduct, etc. are efficiently discharged. In particular, in DMFCs using an aqueous methanol solution as fuel, it is required that methanol should uniformly diffuse into a catalyst layer and a generated carbon dioxide gas should be efficiently discharged. However, since a methanol solution is hydrophilic and a carbon dioxide gas is hydrophobic, it is very difficult to construct a gas diffusion layer and a catalyst layer such that inflow of fuel and discharge of products are efficiently performed. Meanwhile, with respect to an air electrode, efficient discharge of water generated by reaction of hydrogen ions with oxygen in air is the most important issue. In fuel cells, substantial reactions occur in catalyst layers. Thus, in order to enhance reaction efficiency in catalyst layers, it is important to efficiently structure a gas diffusion layer, a catalyst layer, and an interface between the gas diffusion layer and the catalyst layer.

Conventionally, like a method proposed in Japanese Patent Laid-Open Publication No. Hei. 10-289732, research into a gas diffusion layer of an air electrode has been mainly conducted to enhance gas diffusion and water discharge properties by packing carbon powder into the gas diffusion layer. In Korean Patent Publication No. 10-2004-0048309, in order to make a smooth interface between a catalyst layer and a gas diffusion layer, an arithmetic average surface roughness of the gas diffusion layer is adjusted to form a thin and uniform catalyst layer, thereby achieving a uniform supply of a reaction gas and enhancing utilization of the catalyst layer.

According to a conventional method of forming a gas diffusion layer using a carbon slurry including carbon and a polymer resin on a substrate such as a carbon paper or a carbon cloth, a substrate is immersed in a dispersed solution of a water repellent polymer resin, e.g., polytetrafluoroethylene (PTFE), in a solvent (e.g., water), followed by drying and thermal treatment, and a carbon slurry is then coated on the substrate followed by drying and thermal treatment.

A polymer resin such as PTFE or tetrafluoroethylene-hexafluoropropylene copolymer (FEP) is a thermosetting resin that is generally insoluble in water but is commercially available in a suspension state in the presence of a surfactant or the like. The polymer resin in a suspension state does not exhibit an adhesion force, but can be activated to have an adhesion force with heating at 250˜400° C., under a mechanical shear force applied during making slurries, or in the presence of a solvent such as alcohol.

In order to form a microporous layer made of carbon and a hydrophobic polymer on a substrate, Korean Patent Publication No. 10-2004-0048309 discloses a method of preparing a two-layered microporous structure, which includes: impregnating a carbon paper in a FEP dispersed solution followed by sintering at 380° C. for one hour to obtain a water-repellent carbon paper; mixing carbon powder (Vulcan XC-72, Carbot) sieved with a 200 mesh sieve, PTFE, and a solvent to prepare a carbon paste; coating the carbon paste on the water-repellent carbon paper followed by drying; and coating on the resultant structure a carbon paste including carbon powder having a smaller particle size than Vulcan XC-72.

However, in a conventional method of preparing a gas diffusion layer, a carbon paste is too viscous to be coated using a common coating method. Carbon powder, a PTFE polymer, water, and alcohol are mixed and made into a paste while PTFE is activated by alcohol. When a shear force is applied to the carbon paste by further mixing, the viscosity of the carbon paste is increased to hundreds of thousands to millions of cps (corresponding to the viscosity of rubbery clay) due to the characteristics of PTFE. A carbon paste with such a high viscosity is not properly coated on a substrate, such as a carbon paper, and is not adhered to a substrate until a mechanical force is applied thereto.

A substrate for a fuel cell has a hard property, and a carbon paste to be coated thereon also has a hard property due to activation of PTFE. Thus, it is difficult to coat a carbon paste on a substrate.

Korean Patent Application No. 10-2004-0073494 discloses a method of preparing a gas diffusion layer by pressing a plain carbon cloth coated with a coating composition including a fluorinated polymer using calendaring. According to the method, a substrate, such as a carbon paper or a carbon felt, is pressed to about 40-60% of its original thickness, and thus, suffers from a decrease in intrinsic mechanical strength and a change in porosity. In particular, when using a carbon cloth, a microporous layer must be pressed at 132° C. through hot pressing so that the microporous layer is adhered to the carbon cloth. A gas diffusion layer thus prepared has considerable macro-cracks on a surface thereof, thereby causing a non-uniform diffusion of a reaction gas, resulting in a reduction in performance of a fuel cell.

According to a method disclosed in Korean Patent Application No. 10-2004-7009514, carbon particles are subjected to high shear processing to enhance wetting and dispersion properties, and a fluorinated resin is subjected to low shear processing to prevent agglomeration. In this case, however, adhesion to a substrate is still poor.

Meanwhile, it is known that the performance of fuel cells is greatly enhanced when a multi-layered microporous structure is formed on a substrate in such a manner that respective microporous layers have different structures and different materials according to the utilization of the microporous structure and installation of the microporous structure in a cathode or an anode. However, in order to stack microporous layers one onto another using a conventional method, coating-drying-pressing-coating-drying-pressing-thermal treatment, etc. must be performed, and thus, it is very difficult to allow respective microporous layers to have different porosities and different structures as originally intended. Moreover, during pressing, a first microporous layer formed on a substrate may be considerably impregnated into the substrate, thereby significantly lowering the intrinsic porosity of the substrate, and it is difficult to reproducibly adjust the extent of the impregnation.

### BRIEF DESCRIPTION OF THE DRAWINGS

FIG. 1 is a flowchart illustrating a conventional method of preparing a gas diffusion layer for a fuel cell;

FIG. 2 is a flowchart illustrating a method of preparing a gas diffusion layer for a fuel cell according to an embodiment of the present invention;

FIG. 3 is a graph illustrating the performance of membrane electrode assemblies according to Examples and Comparative Example; and

FIG. 4 is photographic images (at ×40 magnification) showing surfaces of gas diffusion layers of fuel cells according to Examples and Comparative Example.

### DETAILED DESCRIPTION OF THE INVENTION

### Technical Problem

The present invention provides a method of reproducibly preparing a gas diffusion layer with a uniform thickness and no cracks based on the principle of a primer coating method, wherein a first microporous layer is hardly impregnated into a substrate and uniformly covers a surface of the substrate, and at least one microporous layer is further coated on the first microporous layer.

The present invention also provides a fuel cell showing improved performance by enhancing utilization of a catalyst layer and guaranteeing a uniform diffusion of fuel and an efficient discharge of a product.

### Technical Solution

According to an aspect of the present invention, there is provided a method of preparing a gas diffusion layer for a fuel cell, the method including:

adding a solvent, a dispersant, and an aqueous polymer resin to carbon powder followed by mixing at high speed to prepare a dispersed solution;

adding a fluorinated resin suspension to the dispersed solution followed by mixing at low speed to prepare a carbon slurry;

coating the carbon slurry on a carbon substrate followed by drying to form a primer layer;

forming a microporous layer on the primer layer; and

thermally treating the resultant structure.

According to another aspect of the present invention, there is provided an electrode for a fuel cell, including a gas diffusion layer prepared according to the above method.

According to another aspect of the present invention, there is provided a fuel cell employing the electrode including the gas diffusion layer prepared according to the above method.

According to the method of preparing the gas diffusion layer of the present invention, penetration of a microporous layer into a substrate can be prevented. Thus, the microporous layer can be uniformly prepared in a reproducible manner, thereby increasing the activity of a catalyst layer, resulting in production of an efficient fuel cell.

Hereinafter, the present invention will be described in more detail.

In a method of preparing a gas diffusion layer for a fuel cell according to the present invention, a carbon slurry is prepared in a soft state having flowability, coated on a substrate, and dried to form a primer layer, and an additional microporous layer is then formed on the primer layer. Thus, the carbon slurry is hardly impregnated into the substrate and filled in concave portions of the substrate to thereby form a gas diffusion layer having a multi-layered microporous structure with a uniform thickness. This is possible since a fluorinated resin is coated in an inactivated state and finally activated when heat is applied thereto. That is, since a coating material for a primer layer has soft characteristics, even when a microporous layer is repeatedly formed on the primer layer, the primer layer can efficiently serve as a crosslinker between a substrate and the microporous layer, thereby enabling the preparation of a gas diffusion layer having a desired structure and porosity without damaging the intrinsic porosity and structure of the substrate. Moreover, a coating material for a primer layer can be easily coated due to its soft characteristics, thereby making it possible to use a common coating method suitable for mass production, e.g., die coating, roll coating, gravure coating, or knife coating, and after drying, no macro-cracks and micro-cracks are observed.

A method of preparing a gas diffusion layer according to the present invention includes: adding a solvent, a dispersant, and an aqueous polymer resin to carbon powder followed by mixing at high speed to prepare a dispersed solution; adding a fluorinated resin suspension to the dispersed solution followed by mixing at low speed to prepare a carbon slurry; coating the carbon slurry on a carbon substrate followed by drying to form a primer layer; forming a microporous layer on the primer layer; and thermally treating the resultant structure.

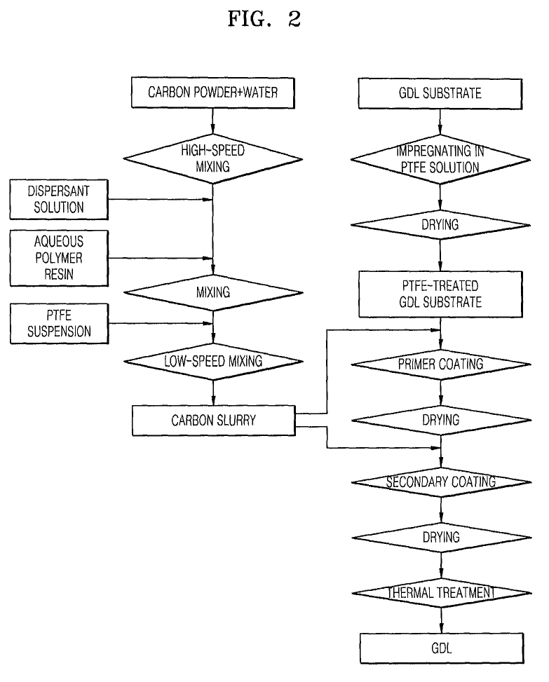

A method of preparing a gas diffusion layer according to the present invention is illustrated in a flowchart of FIG. 2.

The steps of a method of preparing a gas diffusion layer according to the present invention will now be described in more detail.

First, a solvent, a dispersant, and an aqueous polymer resin are added to carbon powder and the mixture is stirred to disperse the carbon powder.

The solvent may be water, n-propanol, isopropanol, or a mixed solvent thereof. The solvent must not activate a fluorinated resin to be added later.

The dispersant for dispersing the carbon powder includes at least one of a cationic surfactant, an anionic surfactant, a nonionic surfactant, and an amphoteric surfactant, which have good compatibility with a fluorinated resin and can disperse the carbon powder. In detail, the dispersant may be selected from cationic surfactants such as alkyltrimethylammonium salts, alkyldimethylbenzylammonium salts, or amine phosphates; anionic surfactants such as polyoxyalkylenealkylethers, polyoxyethylene derivatives, alkylamineoxides, or polyoxyalkyleneglycols; amphoteric surfactants such as alanines, imidazoliumbetains, amidepropylbetains, or aminodiproionates; or nonionic surfactants such as alkylarylpolyetheralcohols, but is not limited thereto. HOSTAPAL and EMULSOGEN (Clariant), Dispersbyk (BYK), Dispers (TEGO), etc. are commercially available as anionic surfactants. A nonionic surfactant may be Triton X-100, etc. Preferably, a material capable of being removed through thermal decomposition at 250˜400° C. may be used as the dispersant.

The aqueous polymer resin can impart an adhesion force to a carbon slurry by linking carbons of the carbon powder, thereby improving slurry characteristics without affecting an electrode reaction in a fuel cell.

In the preparation of the dispersed solution, the solvent, the dispersant, and the aqueous polymer resin can be added at the same time or in sequence.

The aqueous polymer resin is removed through thermal decomposition at 250˜400° C. under an air or oxygen atmosphere, and a resin residue after the removal does not affect an electrode reaction of a fuel cell.

For example, the aqueous polymer resin may be at least one polymer selected from polyethers such as polyethylene oxide, polyethylene glycol, or polyacetaldehyde; polysulfides; polyesters; polycarbonates; ethylene-propylene-elastomers (EPDMs); polyethylenes; polypropylenes; polyvinyls such as PVCs and polyvinylfluorides; and polysaccharides such as celluloses, cellulose derivatives, and starches.

When performing mixing at high speed to prepare the dispersed solution, the mixing speed may be 500 to 10,000 rpm. If the mixing speed is less than 500 rpm, the carbon powder may not be effectively dispersed. On the other hand, if the mixing speed exceeds 10,000 rpm, excess heat may be generated in the slurry, thereby changing the composition of the slurry.

A fluorinated resin suspension is added to the dispersed solution followed by mixing at low speed to make a carbon slurry. The carbon slurry has different flowability and viscosity according to the amount of a used solvent. The carbon slurry may have a viscosity of about 100-500,000 cps according to a coating method.

The fluorinated resin may be used in an amount of 5 to 100 parts by weight, more preferably 10 to 30 parts by weight, based on 100 parts by weight of the carbon powder. If the content of the fluorinated resin is less than 5 parts by weight, adhesion of the slurry may be lowered, thereby lowering a mechanical strength. On the other hand, if it exceeds 100 parts by weight, electrode resistance may be increased.

The fluorinated resin may include at least one of polytetrafluoroethylene (PTFE), tetrafluoroethylene-perfluoroalkylvinylether copolymer (PFA), tetrafluoroethylene-hexafluoropropylene copolymer (FEP), polychlorotrifluoroethylene (PCTFE), tetrafluoroethylene-ethylene copolymer (ETFE), and polyvinylidene fluoride (PVDF).

When mixing the fluorinated resin with the dispersed solution at low speed, the mixing speed may be 10 to 500 rpm. If the mixing speed is less than 10 rpm, the fluorinated resin may not be sufficiently dispersed in the slurry. On the other hand, if the mixing speed exceeds 500 rpm, the fluorinated resin may be fibrosed due to a shear force.

The carbon slurry includes carbon powder with porosity and electrical conductivity. The carbon powder may be active carbon, active carbon fiber, carbon black, carbon aero-sol, carbon nanotube, carbon nanofiber, carbon nanohom, natural or synthetic graphite, or a mixture thereof, but is not limited thereto. The average particle size, surface area, average pore size, etc. of the carbon powder are not particularly limited. However, if the average particle size of the carbon powder is too small, access of fuel and a reaction gas to a catalyst layer may be inhibited, and discharge of carbon dioxide and water produced during reaction may not be efficiently performed. On the other hand, if the average particle size of the carbon powder is too large, macro-pores may be created, thereby lowering a fuel loading capacity, and interfacial resistance between electrons produced during reaction and a current collector may be excessively increased. In this regard, the average particle size of the carbon powder may be about 20 to 5,000 nm.

The carbon slurry is coated on a carbon substrate and dried to form a primer layer. Before forming the primer layer, the carbon substrate may be pretreated with a water repellent in such a manner that it is immersed in a water repellent solution and dried.

The carbon substrate may be a carbon paper, a carbon cloth, a carbon felt, a carbon sheet, or the like, but is not limited thereto.

A water repellent capable of forming capillary tubes for gas passage may be at least one fluorinated resin selected from the group consisting of polytetrafluoroethylene (PTFE), tetrafluoroethylene-perfluoroalkylvinylether copolymer (PFA), tetrafluoroethylene-hexafluoropropylene copolymer (FEP), polychlorotrifluoroethylene (PCTFE), tetrafluoroethylene-ethylene copolymer (ETFE), and polyvinylidene fluoride (PVDF). A suspension including such a fluorinated resin may be used as a water repellent solution. A water repellent-treated substrate is not sintered until a primer layer (a first microporous layer) is coated thereon.

The content of the water repellent in the substrate may be about 1 to 60 wt %, more preferably about 2 to 45 wt %, and still more preferably about 5 to 40 wt %.

A second microporous layer is formed on the primer layer. The microporous layer may be formed by repeating the coating and drying of the above-described carbon slurry or a conventional carbon slurry once or more than once.

Carbon slurries to be coated on the primer layer may have compositions which are the same as or different from each other. The carbon slurry may be repeatedly coated to a total thickness of 20-200 μm on the primer layer to form a uniform microporous layer. By forming the microporous layer, formation of micro-cracks that are generally caused with an increase in thickness of a gas diffusion layer does not occur, and a thickness variation can be minimized (±5%).

If the specific surface area of the carbon powder is too small, a fuel loading capacity may be lowered, and a contact resistance with a catalyst may be increased. On the other hand, if the specific surface area of the carbon powder is too large, a reaction product may not be efficiently discharged due to excessive microporosity. In this regard, the specific surface area of the carbon powder may be about 20 to 2,000 m²/g, more preferably, about 50 to 1,500 m²/g, and still more preferably, about 80 to 800 m²/g

The coating process mentioned herein may be performed using a common coating method, e.g., die coating, comma coating, bar coating, gravure coating, or knife coating.

The primer layer is hardly impregnated in the substrate and can partially or wholly cover a surface of the substrate. The thickness of the primer layer on the substrate may be 1-50 μm, more preferably 2-20 μm.

When forming the microporous layer using the above-described carbon slurry, if the content of the fluorinated resin is too small, the mechanical strength of a gas diffusion layer may be excessively lowered. On the other hand, if the content of the fluorinated resin is too large, pores of the microporous layer may be clogged, thereby blocking an efficient supply of fuel and a reaction gas into a catalyst layer, and further, electrical resistivity of a gas diffusion layer may be excessively increased. In this regard, the content of the fluorinated resin in the microporous layer may be 5 to 100 parts by weight, preferably 10 to 30 parts by weight, based on 100 parts by weight of the carbon powder.

When forming a multi-layered microporous structure on the primer layer, the thickness of a first microporous layer is not limited and may be adjusted according to electrode characteristics. With respect to additional microporous layers (e.g., second and third microporous layers) formed on the first microporous layer, the thickness and composition may be changed considering fuel supply and product discharge in a fuel cell, electrical resistivity, and the reaction efficiency of a catalyst. If the total thickness of the microporous layers is too thin, a fuel supply may not be uniformly performed, and the reaction efficiency of a catalyst may be lowered. On the other hand, if the total thickness of the microporous layers is too thick, supply of fuel and a reaction gas into a catalyst layer may not be efficiently performed, and electrode resistance may be increased, thereby lowering the characteristics of a fuel cell.

Generally, a gas diffusion layer prepared using the method of preparing the gas diffusion layer according to the present invention may have electrical resistivity (in-plane and thru-plane resistivity) of about 1 Ω/cm or less, more preferably about 0.1 Ω/cm or less, and still more preferably, about 0.01 Ω/cm or less.

The resultant structure is thermally treated in an oven of 250-400° C. At this time, a fluorinated resin of a part of the primer layer impregnated in the substrate and a fluorinated resin of the microporous layer formed on the primer layer are melted to have an adhesion force, and the aqueous polymer resin, the dispersant, etc. in the carbon slurry used to form the microporous layer are decomposed and removed or carbonized during the thermal treatment. The thermal treatment is performed at 350° C. in air.

That is, in the method of preparing the gas diffusion layer according to the present invention, after thermal treatment, only a fluorinated resin is left in a substrate, and only pure carbon powder and a fluorinated resin are left in a microporous layer to thereby form a multi-layered gas diffusion layer.

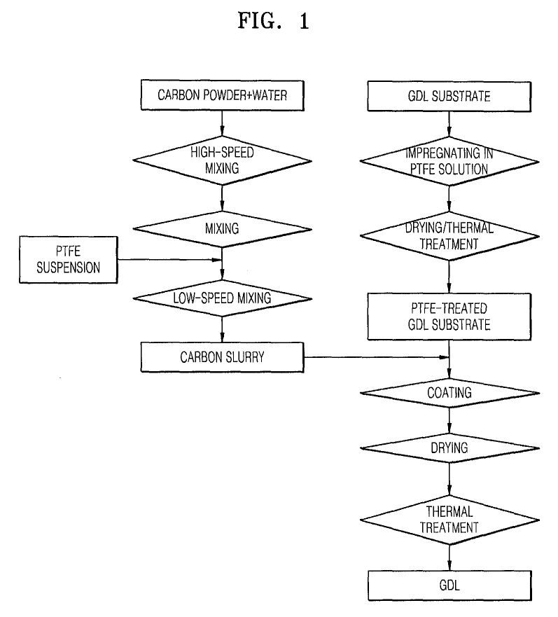

A gas diffusion layer prepared using the method of preparing the gas diffusion layer according to the present invention has a smaller interfacial resistance than a gas diffusion layer prepared using a conventional method. In a conventional method illustrated in FIG. 1, a substrate is immersed in a water repellent solution, dried, and thermally treated (i.e., sintering). Then, a carbon paste is coated on the substrate, dried, and sintered to form a gas diffusion layer. Since the carbon paste is coated on the previously sintered substrate and sintered, a fluorinated resin of the substrate has different characteristics than a fluorinated resin of a microporous layer, thereby increasing interfacial resistance. Also, when using a substrate which is not pretreated with a water repellent solution including a fluorinated resin, a large amount of a fluorinated resin is impregnated in the substrate during coating a carbon paste, thereby making it difficult to uniformly adjust the extent of the impregnation.

On the contrary, in the method of preparing the gas diffusion layer according to the present invention, after forming a primer layer on a substrate, the coating and drying of a carbon slurry or a carbon paste are repeated once or more than once to form a multi-layered microporous structure, and the resultant structure is finally sintered. Thus, a polymer resin of the primer layer with good adhesion to the substrate and a fluorinated resin of each microporous layer are connected to form a network, thereby decreasing interfacial resistance and remarkably decreasing the penetration resistance of an electrode. Therefore, the reaction efficiency of the electrode is increased, thereby enhancing the performance of a fuel cell.

The present invention also provides an electrode for a fuel cell, including a gas diffusion layer prepared according to the above-described method and a catalyst layer. Here, the term “electrode for a fuel cell” refers to an anode or a cathode used in a fuel cell. Oxidation of fuel occurs in a catalyst layer of an anode, and reduction of oxygen occurs in a catalyst layer of a cathode. For example, catalyst layers of an anode and a cathode of a polymer electrolyte membrane fuel cell (PEMFC) or a direct methanol fuel cell (DMFC) generally include respective catalysts for catalyzing oxidation of fuel and reduction of oxygen, and a hydrogen ion conductive binder resin for immobilizing the catalysts and maintaining the mechanical strength of the catalyst layers.

The catalysts may be metal catalysts or supported catalysts. The term “metal catalyst” refers to a catalytic metal powder capable of inducing the oxidation of fuel or the reduction of oxygen. The term “supported catalyst” refers to a catalyst composed of a microporous catalyst support and catalytic metal particles supported on the catalyst support. The catalytic metal particles may be platinum powder, Pt—Ru powder, or the like, but are not limited thereto. The catalyst support may be active carbon, carbon nanotube, carbon nanohorn, artificial or natural carbon black, or the like.

The hydrogen ion conductive binder resin may be a polymer having a cation exchange group such as a sulfonyl group, a carboxyl group, a phosphonyl group, an imide group, a sulfonimide group, a sulfonamide group, or a hydroxy group. Examples of the cation exchange group-containing polymer include homopolymers or copolymers of trifluoroethylene, tetrafluoroethylene, styrene-divinyl benzene, α,β,β-trifluorostyrene, styrene, imide, sulfone, phosphazene, etherether ketone, ethylene oxide, polyphenylene sulfide, or aromatic group, and derivatives thereof. These polymers may be used alone or in combination. More preferably, the cation exchange group-containing polymer may be a highly fluorinated polymer in which 90% or more of the total number of fluorine and hydrogen atoms bound to carbon atoms in the main and side chains of the polymer are fluorine atoms. The cation exchange group-containing polymer may also include sulfonate as a cation exchange group at an end of the side chain. Thus, the cation exchange group-containing polymer may be a highly fluorinated polymer with sulfonate groups in which 90% or more of the total number of fluorine and hydrogen atoms bound to carbon atoms in the main and side chains of the polymer are fluorine atoms.

The catalyst layer can be prepared, for example, using the following method. That is, an electrode including a catalyst layer and a diffusion layer can be manufactured using a method including: (i) uniformly dispersing a catalyst and a hydrogen ion conductive binder resin in a solvent to prepare a catalyst ink, (ii) uniformly coating the catalyst ink on the diffusion layer using a method such as printing, spray, rolling, or brushing, and (iii) drying the resultant structure to form the catalyst layer.

The present invention also provides a fuel cell including an anode, a cathode, and a hydrogen ion conductive electrolyte membrane, wherein at least one of the anode and the cathode includes a gas diffusion layer prepared using a method of preparing a gas diffusion layer according to the present invention.

The fuel cell of the present invention can be applied to, for example, phosphoric acid fuel cells (PAFCs), PEMFCs, DMFCs, etc. The constructions and manufacturing methods of these fuel cells are known in many documents and would have been obvious to a person skilled in the art. Thus, a detailed description thereof will be omitted.

### ADVANTAGEOUS EFFECTS

A gas diffusion layer prepared using a method of preparing a gas diffusion layer according to the present invention has sufficiently uniform electronic conductivity to be efficiently electrically connected to an external electrical circuit, and at the same time, has enough porosity to permit easy access of fuel and a reaction gas to a catalyst layer.

Moreover, according to a method of preparing a gas diffusion layer of the present invention, a gas diffusion layer can be easily prepared in various shapes according to the needs of a user since it is easy to modify the shape of the gas diffusion layer during the preparation.

An electrode and a fuel cell according to the present invention can show improved performance by employing a gas diffusion layer prepared using a method of preparing a gas diffusion layer according to the present invention. The present invention is not limited to a polymer fuel cell employing a gas diffusion layer. Various types of fuel cells employing a gas diffusion layer, e.g., PAFCs, formic acid fuel cells, and dimethylether fuel cells are also within the principle and scope of the present invention.

### BEST MODE FOR CARRYING OUT THE INVENTION

Hereinafter, the present invention will be described more specifically with reference to the following examples. The following examples are for illustrative purposes and are not intended to limit the scope of the invention.

### Examples

### Example 1

1,000 g of ultra pure water was added to Vulcan XC-72 (Cabot) and the components were blended in a high-speed mixer (2,000 rpm). A dispersant, Triton X-100 was added thereto and the components were dispersed for one hour. 30 g of carboxymethylcellulose was added to the dispersed solution, and the components were further dispersed for one hour. 30 wt % of PTFE (30J, Dupont) was added to the dispersed solution, and the components were stirred in a low-speed mixer (200 rpm) for one hour to make carbon slurries. At this time, the content of PTFE was adjusted to 30 parts by weight based on 100 parts by weight of the carbon powder.

Carbon substrates (TGPH-060, Toray) were immersed in a PTFE suspension for five minutes and dried in a 80° C. dry oven for one hour so that the content of PTFE was 30 wt %. Then, the carbon slurries were coated on the carbon substrates using a knife coating method and dried in a 80° C. dry oven for one hour to obtain primer layers with a thickness of 10 μm. Then, the same carbon slurries were coated on the primer layers and dried to obtain gas diffusion layers with a total thickness of 40 μm. The gas diffusion layers were sintered in a 350° C. oven for 30 minutes.

In order to form catalyst layers, Pt—Ru powder and Nafion were added to a mixed solvent of isopropyl alcohol and water (1:1 by weight), and the components were dispersed in an ultrasonic bath for about 10 minutes. Catalyst ink thus prepared was spray-coated on the gas diffusion layers in which 5 wt % of PTFE was impregnated in the substrates, and dried to obtain anodes. At this time, the content of Nafion in the dried catalyst layers was about 10 wt %, and a catalyst loading amount in the anodes was about 5 mg/cm².

Pt black powder and Nafion were added to a mixed solvent of isopropyl alcohol and water (1:1 by weight), and the components were dispersed in an ultrasonic bath for about 10 minutes. Catalyst ink thus prepared was spray-coated on the gas diffusion layers in which 40 wt % of PTFE was impregnated in the substrates, and dried to obtain cathodes. At this time, the content of Nafion in the dried catalyst layers was about 10 wt %, and a catalyst loading amount in the cathodes was about 5 mg/CT.

Nafion 115 (Dupont) was pretreated with hydrogen peroxide and sulfuric acid to remove surface organic materials, and sodium ions of Nafion functional groups were replaced with hydrogen ions, to thereby prepare hydrogen ion conductive polymer electrolyte membranes.

The anodes and the cathodes were cut into 5 cm (width)×5 cm (length) in size, and the hydrogen ion conductive electrolyte membranes were cut into 7 cm (width)×7 cm (length) in size which was larger than the electrodes. The catalyst layers of the anodes and the catalyst layers of the cathodes were disposed to contact with the hydrogen ion conductive electrolyte membranes, and the resultant structures were pressed at about 140° C. under a pressure of 100 kg_{f}/cm² for three minutes to manufacture MEAs.

The MEAs were arranged in a unit cell test jig. A 2M methanol solution was supplied to the anodes at a rate of 1 Ml/min using a pump, and oxygen was supplied to the cathodes at a rate of 1 Ml/min. An electronic load was connected to the unit cells under 50° C. operation conditions to measure a voltage drop with respect to current density.

### Example 2

Gas diffusion layers and fuel cells including the same were manufactured in the same manner as in Example 1 except that carbon cloths (AvCarb™ 1071 HCB or AvCarb™ 1071 CCB, Ballard Material Products) were used as substrates of the gas diffusion layers. A voltage drop with respect to current density of the fuel cells was measured.

### Comparative Example

Gas diffusion layers were prepared using a method as illustrated in FIG. 1. Fuel cells were manufactured in the same manner as in Example 1 except that LT-1400W in which microporous layers were coated on commercially available carbon cloths (E-TEK, U.S.A.) was used as gas diffusion layers of anodes, and SGL-10BC (SGL) in which microporous layers were coated on carbon felts impregnated with 5% of PTFE was used as gas diffusion layers of cathodes. A voltage drop with respect to current density of the fuel cells was measured.

<Evaluation Results>

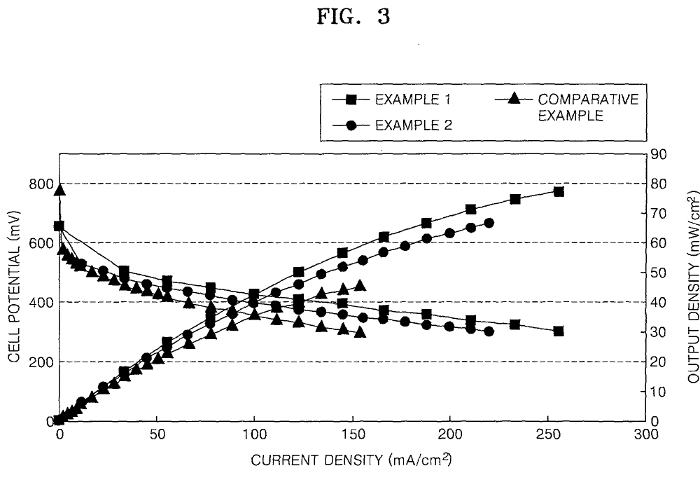

Voltage drop curves for the fuel cells manufactured in Examples 1-2 and Comparative Example are illustrated in FIG. 3.

Referring to FIG. 3, the curves of a voltage drop with respect to current density in the fuel cells of Examples 1-2 are more gentle than that in the fuel cells of Comparative Example. Such gentle voltage drop curves in the fuel cells of Examples 1-2 show that a polymer electrolyte membrane fuel cell according to the present invention can respond more rapidly to a load change than a conventional polymer electrolyte membrane fuel cell. Moreover, the maximum current density of the fuel cells of Examples 1-2 is greater than that of the fuel cells of Comparative Example. When a maximum current density is enhanced, a maximum supply power is also enhanced. This results from uniform formation of a microporous layer and no occurrence of cracks.

From the above results, it can be seen that a gas diffusion layer prepared using a method of preparing a gas diffusion layer according to the present invention has sufficiently uniform electronic conductivity to be efficiently electrically connected to an external electrical circuit, and at the same time, has enough porosity to permit easy access of fuel and a reaction gas to a catalyst layer, thereby improving the performance of fuel cells.

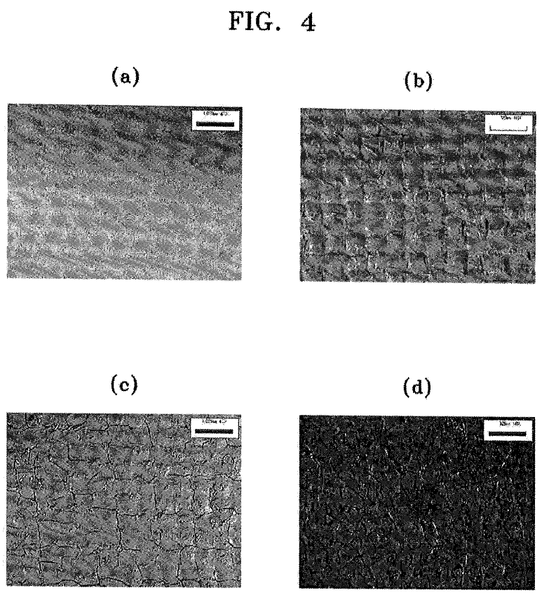

Surface images of the gas diffusion layers for the anodes in Example 1 (FIG. 4(a)) and Example 2 (FIG. 4(b)), and the gas diffusion layers for the anodes (i.e., LT-1400W in which carbon paste was coated on carbon cloths (E-Tek)) (FIG. 4(c)) and the gas diffusion layers for the cathodes (e.g., SGL-10BC (SGL)) (FIG. 4(d)) in Comparative Example are shown in FIG. 4. Referring to FIG. 4, the gas diffusion layers of Examples 1-2 according to the present invention hardly suffered from impregnation of a microporous layer into a carbon paper or a carbon cloth and had a smooth surface to cover the surface irregularities of the substrate and no surface cracks. On the contrary, with respect to the commercially available gas diffusion layers, a microporous layer was well impregnated into a substrate. In particular, with respect to the gas diffusion layers produced by SGL, a microporous layer was impregnated in 50% of a substrate, and many cracks and undispersed particle agglomerates were observed. When cracks are present in a gas diffusion layer responsible for fuel supply and product discharge, fuel and reactants are non-uniformly distributed, and thus, a catalyst reaction occurs non-uniformly over the entire surface of a catalyst layer, thereby causing a reduction in reaction efficiency and adversely affecting a catalyst lifetime due to partial degradation of a catalyst. In particular, when cracks are created in a gas diffusion layer for an anode, the cross-over ratio of a methanol solution toward a polymer membrane and a cathode is increased, thereby decreasing the reaction efficiency of the cathode and a cell voltage, resulting in significant deterioration in characteristics of fuel cells.

However, a gas diffusion layer prepared using a method of preparing a gas diffusion layer according to the present invention has no surface cracks and guarantees a uniform distribution of fuel.

1. A method of preparing a gas diffusion layer for a fuel cell, the method comprising:
adding a solvent, a dispersant, and an aqueous polymer resin to carbon powder followed by mixing at high speed to prepare a dispersed solution;
adding a fluorinated resin suspension to the dispersed solution followed by mixing at low speed to make a carbon slurry;
coating the carbon slurry on a carbon substrate followed by drying to form a primer layer;
forming a microporous layer on the primer layer; and
thermally treating the resultant product.

2. The method of claim 1, wherein the carbon powder is at least one selected from the group consisting of active carbon, active carbon fiber, carbon black, carbon aero-sol, carbon nanotube, carbon nanofiber, carbon nanohorn, and natural or synthetic graphite.

3. The method of claim 1, wherein the carbon powder has an average particle size of 20 to 2,000 nm.

4. The method of claim 1, wherein the carbon powder has a specific surface area of 20 to 2,000 m²/g.

5. The method of claim 1, wherein the fluorinated resin is at least one selected from the group consisting of polytetrafluoroethylene (PTFE), tetrafluoroethylene-perfluoroalkylvinylether copolymer (PFA), tetrafluoroethylene-hexafluoropropylene copolymer (FEP), polychlorotrifluoroethylene (PCTFE), tetrafluoroethylene-ethylene copolymer (ETFE), and polyvinylidene fluoride (PVDF), and wherein the fluorinated resin is used in an amount of 5 to 100 parts by weight based on 100 parts by weight of the carbon powder.

6. The method of claim 1, wherein the carbon substrate is pretreated with a water repellent by impregnating the carbon substrate in a water repellent solution followed by drying.

7. The method of claim 6, wherein the water repellent is selected from the group consisting of polytetrafluoroethylene (PTFE), tetrafluoroethylene-perfluoroalkylvinylether copolymer (PFA), tetrafluoroethylene-hexafluoropropylene copolymer (FEP), polychlorotrifluoroethylene (PCTFE), tetrafluoroethylene-ethylene copolymer (ETFE), and polyvinylidene fluoride (PVDF).

8. The method of claim 1, wherein the primer layer is formed to a thickness of 1 to 50 μm.

9. The method of claim 1, wherein the microporous layer is formed to a total thickness of 20 to 200 μm.

10. The method of claim 1, wherein in the formation of the microporous layer, a carbon slurry or a carbon paste is coated on the primer layer and dried, and the coating and the drying is performed once or more than once.

11. The method of claim 1, wherein the carbon substrate is at least one selected from the group consisting of carbon cloth, carbon paper, carbon felt, and carbon sheet.

12. The method of claim 1, wherein the dispersant is at least one selected from the group consisting of an anionic surfactant, a cationic surfactant, an amphoteric surfactant, and a nonionic surfactant.

13. The method of claim 1, wherein the aqueous polymer resin is a polymer resin that can be carbonized at 250˜400° C. under an air or oxygen atmosphere.

14. An electrode for a fuel cell, comprising a gas diffusion layer prepared according to the method of claim 1.

15. A fuel cell comprising the electrode of claim 14.
